(19) United States
(12) Patent Application Publication
(10) Pub. No.: US 2019/0084221 A1
(43) Pub. Date: Mar. 21, 2019

(54) PACKAGING METHOD

(71) Applicants: MIMAKI ENGINEERING CO., LTD., Nagano (JP); GRAPHIC CREATION Co., Ltd.,, Nagano (JP)

(72) Inventors: Kunio Hakkaku, Nagano (JP); Hirofumi Hara, Nagano (JP)

(73) Assignees: MIMAKI ENGINEERING CO., LTD., Nagano (JP); GRAPHIC CREATION Co., Ltd.,, Nagano (JP)

(21) Appl. No.: 16/133,727

(22) Filed: Sep. 18, 2018

(30) Foreign Application Priority Data
Sep. 19, 2017 (JP) 2017-178834
Jul. 30, 2018 (JP) 2018-142824

(51) Int. Cl. B29C 64/112; B29C 64/40; B65D 5/50

(52) U.S. Cl. CPC B29C 64/112; B33Y 10/00; B65D 5/509; B29C 64/40

(57) ABSTRACT

A packaging method for packaging a molded object which is a stereoscopic object includes: a step of accommodating the molded object and a filling material in a storage container so that a periphery of the molded object is surrounded by the filling material; and a step of fixing a position of the filling material to prevent at least a part of the filling material from moving relative to the molded object in the storage container when the storage container is applied with a shock less than or equal to a preset magnitude wherein the molded object is in a state in which the filling material comes into contact with the molded object.

### CROSS REFERENCE TO RELATED APPLICATIONS

This application claims the priority benefit of Japanese Patent Application No. 2017-178834 filed on Sep. 19, 2017 and Japanese Patent Application No. 2018-142824 filed on Jul. 30, 2018. The entirety of the above-mentioned patent applications is hereby incorporated by reference herein and made a part of this specification.

### TECHNICAL FIELD

The present disclosure relates to a packaging method.

### DESCRIPTION OF THE BACKGROUND ART

In recent years, a molding apparatus (3D printer) for molding molded objects having various three-dimensional shapes is becoming widespread. Such a molding apparatus molds the molded objects by various methods such as a lamination molding method (see, for example, Japanese Unexamined Patent Publication No. 2015-71282).

### SUMMARY

For molding a molded object by a molding apparatus, it may be necessary to transport (ship) the molded object to another location after molding is completed. Here, depending on a shape of the molded object, it is necessary to package the molded object using a packaging box or the like in order to suppress the influence of a shock during transportation, for example. In this case, a buffering material (cushioning material) for buffering the shock may be used to prevent the molded object from being damaged even when the molded object is shaken by the shock applied to the packaging box during transportation. As the cushioning material, for example, a polyethylene air bubble cushioning material, a polyurethane foam cushioning material, a sponge and the like are used. Such a method is actually effective to some extent.

However, as a result of actually performing an experiment or the like to transport molded objects having various shapes, the inventors of the present application have found that in the case of transporting a fragile molded objects such as molded objects (for example, thin molded objects, fine molded objects or the like) having, for example, a portion of a fine structure, even when the fragile molded objects are packaged with the cushioning material as described above, there are cases in which a damage to the molded objects may not be sufficiently prevented. The inventor of the present application has also found that the cause of the damage is that for example, in the case of using the cushioning material as described above, the cushioning material or the molded object moves slightly due to the shock or the like during transportation, and thus the cushioning material partially presses strongly against the molded object. A movement of such cushioning material or molded object may be caused due to not only the strong impact applied to the cushioning material or the molded object but also a partial variation of a static pressure due to the unevenness of the arrangement between the buffering material and the molded object, a slight operation before and after transportation or during long-term storage, or the like. Therefore, in this case, it is also considered that for example, the portion of the fine structure of the molded object is damaged, before and after the transportation or during the long-term storage. Also, as a result, the molded object is exposed to a risk of damage without being limited to during transportation.

In contrast, when for example, a polyurethane foam cushioning material is used as the cushioning material, the polyurethane foam cushioning material is configured to swell to fix the molded object in the packaging box, so that the cushioning material or the molded object is hardly to move in the packaging box. However, in this case, a strong force is partially applied to the molded object at a timing when the polyurethane foam cushioning material swells or at a timing when the cushioning material is removed after the transportation. As a result, it is considered that the strong force is a cause of the damage to the molded object or the like having the portion of the fine structure. In this case, if the molded object is made of, for example, resin or the like, the molded object is likely to be deformed due to the influence of heat generation at the time of the foaming.

For a molded object manufactured by using, for example, gypsum as a material, even if such a cushioning material is used, the molded object is particularly liable to be damaged due to its brittleness. The molded objects to be molded by the molded apparatus are not usually mass-produced products. For this reason, it is usually costly to manufacture a member such as a blister case for transportation. Further, the molding apparatus may also manufacture the molded object while forming a support layer supporting a periphery of the molded object during molding. In this case, it may be considered that the damage to the molded object can be suppressed by transporting the molded object while leaving the support layer. However, in this case, a side (for example, the customer side) receiving the transported molded object needs to remove the support layer, which puts a heavy burden on the side receiving the molded object.

The above problem similarly arises not only when the molded object molded by the molding apparatus is transported but also when various three-dimensional objects (objects) are packaged. Therefore, conventionally, it was desired to package the three-dimensional objects by a more appropriate method. Accordingly, the present disclosure provides a packaging method that can solve the above problems.

The inventor of the present application has further studied the cause of the damage in the state in which the three-dimensional portions such as the molded object are packaged. Specifically, for example, experiments and the like for transporting three-dimensional objects are repeatedly performed to confirm the situation in which the three-dimensional objects are damaged during transportation or packaging. It was found based on a confirmation result and the like that the movement of the molded object with respect to the surrounding cushioning material in the packaging box tends to be the cause of the damage. Based on such knowledge, it was considered that the damage is suppressed if the molded object and objects therearound do not move relative to each other in the packaging box. In order to satisfy such a condition, it is considered that the molded object is completely buried in the packaging box filled with a filling material of, for example, powder or granule (powdery or particulate filling material) and is applied with a pressure from, for example, one direction to fix the relative position of the filling material to the molded object. In this case, by using the repulsion from the packaging box, the molded object is subject to a compression from all directions according to a law of action and reaction. Also, due to the compression, the molded object or the filling material therearound does not move relative to each other in the packaging box.

It is considered that the damage to the packaged molded object is particularly likely to occur when the portion of the molded object to be easily damaged is pressed from one direction. In contrast, if the molded object is packaged in a manner that the molded object is pressed from all directions with the same force, the damage to the molded object can be more appropriately prevented. In addition, the inventor of the present application confirmed that the effect of preventing damage can be appropriately obtained by repeatedly performing experiments to transport the packaged molded object under such conditions. By further earnest research, the inventors have found the necessary characteristics to obtain such effects to complete the present disclosure.

To solve the problem, according to the present disclosure, there is provided a packaging method for packaging a three-dimensional object which is a stereoscopic object, including: a step of accommodating a three-dimensional object and a filling material in a storage container so that a periphery of the three-dimensional object is surrounded by the filling material by using the storage container which is a container accommodating the three-dimensional object and the filling material which is a material filled in the storage container; and a step of fixing a position of the filling material to prevent at least a part of the filling material from moving relative to the three-dimensional object in the storage container when the storage container is applied with a shock less than or equal to a preset magnitude by fixing a relative position of at least the filling material around the three-dimensional object, wherein the three-dimensional object is in a state in which the filling material comes into contact with the three-dimensional object.

In such a configuration, for example, by preventing the filling material from moving with respect to the three-dimensional object in the storage container, for example, it is possible to appropriately prevent the three-dimensional object or the filling material from moving in the storage container. In this way, for example, it is possible to appropriately prevent the three-dimensional object from being damaged even when the storage container is applied with a shock during transportation. Therefore, by such a configuration, for example, it is possible to appropriately package the three-dimensional object.

Here, regarding the shock applied to the storage container, a shock which is less than or equal to the preset magnitude is, for example, a shock less than or equal to an upper limit which is set according to a required shock resistance. In this method, surrounding the periphery of the three-dimensional object by the filling material means that the entire of the periphery of the three-dimensional object is surrounded by the filling material by, for example, burying the three-dimensional object in the filling material. As the filling material, for example, it is preferable to use a filling material that does not firmly adhere to the three-dimensional object even when the filling material comes into contact with the three-dimensional object and is easily removed from the three-dimensional object. Depending on the shape of the three-dimensional object or the like, there may be cases in which it is sufficient to protect only the fragile part (a part of the three-dimensional object) which is easily damaged due to, for example, the shock or the like. In such a case, it is also conceivable to perform the packaging so that only a part of the three-dimensional object is buried in the filling material. In this case, it can be considered that surrounding the periphery of the three-dimensional object by the filling material is a state in which a part of the periphery of the three-dimensional object is surrounded by the filling material, or the like.

Further, examples of the filling material to be used include powder, granule or the like. In this case, it is preferable to use dried powder or granule. More specifically, silica gel or starch may be used as the filling material. Sand or the like may be used as the filling material. As the filling material, a desiccant other than the silica gel, various organic materials, inorganic materials, or the like, may be used, without being limited thereto. Examples of the filling material to be used include pearlite, vermiculite or the like. As the filling material, one kind of filling material is not used, but plural kinds of filling materials may be used in combination. Examples of the filling material to be used include a hollow resin or the like. The configuration of using powder or granule as the filling material, for example, can be considered as a configuration of using a filling material made of a plurality (a large number) of materials. By employing such a configuration, for example, regarding the filling material coming into contact with the three-dimensional object, even when the shock is applied to the storage container, the filling material can be prevented from moving with respect to the three-dimensional object. When focused on these features, regarding the operation of fixing the position of the filling material, for example, with regard to the filling material having fluidity, it can be considered to perform the operation of fixing the relative position of the filling material with respect to the three-dimensional object while the filling material comes into contact with the three-dimensional object. In this case, as the powder or granule, it is preferable to use powder or granule material having fluidity. The fact that the powder or granule has fluidity means, for example, that a large number of powders and granules are an aggregate and have fluidity. In this case, since the powder or granule has fluidity, for example, the filling material is filled around the three-dimensional object without a space at the time of the filling. As a result, a movement of the three-dimensional object due to the external shock from the outside is suppressed, and the damage to the three-dimensional object can be appropriately prevented. A part of the filling material may be replaced by solid matters such as resin, metal, and wood chip. In this case, it is preferable to fill the solid matters at a position sufficiently separated in a range not contacting the three-dimensional object.

In this case, as the storage container, for example, a container having a fixed shape can be appropriately used. The storage container having a fixed shape is not a deformable container such as a plastic bag or the like, but a container that keeps a fixed shape even when the contents are empty (a hard container). It is preferable that the filling material in the storage container be in a state of fine filling after the operation of fixing the position of at least the filling material. With such a configuration, for example, it is possible to appropriately realize the state in which at least the filling material coming into contact with the three-dimensional object does not move relative to the three-dimensional object even when the shock is applied to the storage container. As the filling material, it is preferable to use an inelastic material. With this configuration, for example, it is possible to appropriately perform the filling by fine filling without collapsing of the filling material or the like and without forming a space between the three-dimensional objects. In this case, it can be considered to apply pressure to the filling material using a known cushioning material or the like for packaging. More specifically, in this case, for example, the cushioning material or the like is further accommodated in the storage container so as to come into contact with the filling material from the outside in the storage container, and the pressure can be applied to the filling material via the cushioning material or the like by applying a force to compress the cushioning material or the like. In this case, as the cushioning material or the like, for example, the polyurethane cushioning material, the polyurethane foam cushioning material, a sponge, an air cushion, cotton, or the like can be suitably used. In this case, for example, it is preferable to install the cushioning material or the like so as to press the filling material from one direction. With this configuration, for example, it is possible to appropriately apply the pressure to the filling material in the storage container.

In order to more appropriately prevent the three-dimensional object from being damaged or the like, it is preferable to sufficiently reduce a dimension (size) of the filling material as compared to a dimension of the fragile part of the three-dimensional object. More specifically, in this case, for example, when a size of the fragile part in the three-dimensional object is about 2 mm, it is preferable to use the powder, the granule or the like having the dimension of 2 mm or less as the filling material. In this case, the dimension of the filling material such as powder and granule means a substantial dimension which is statistically obtained like an average dimension, for example. For performing the packaging by such a method, the three-dimensional object can be appropriately packaged without using the blister case for transportation or the like, such that the three-dimensional object having various shapes can be appropriately packaged at low cost. Therefore, as the three-dimensional object to be packaged, for example, the molded object or the like which is molded by the molding apparatus (three-dimensional molding apparatus) can be suitably used. More specifically, in this case, as the molding apparatus, for example, the molding apparatus that perform is the molding by an inkjet stacking method of stacking ink layers formed by the inkjet head into a plurality of layers, the molding apparatus that performs the molding by the powder stacking method, or the like can be suitably used.

The specific packaging method and the like in the packaging method are not limited to the above description and can also be modified variously. For example, in the accommodating step, it is also conceivable to fill at least a part of the space between the filling materials with a liquid. With this configuration, for example, by filling the space of the filling material with the liquid, it is possible to more appropriately prevent the movement of the contents of the storage container. In order to more reliably prevent the three-dimensional object from being damaged, for example, it is also conceivable to perform the packaging using an exterior member, which is a member covering the outside of the storage container, plural times. In this case, for example, it is also conceivable to further perform the operation of covering the storage container and the cushioning material with the exterior member by bringing at least a part of a periphery of the storage container into contact with the cushioning material.

As the filling material, other materials than the powder or granule may be used. In this case, for example, a material or the like may be used which undergoes a phase transition from a liquid state to a solid state during the packaging operation. More specifically, in this case, for example, in the accommodating step, the filling material in the liquid state is filled in the storage container. In the step of fixing the position of the filling material, it can be considered to undergo a phase transition of the filling material to the solid state. Even in such a case, it is possible to appropriately prevent the three-dimensional object and the filling material from moving in the storage container during the transportation of the three-dimensional object. This makes it possible to appropriately prevent the three-dimensional object from being damaged. As such a filling material, for example, fat and oil or the like may be used. In this case, in the accommodating step, for example, a temperature of the fat and oil is a temperature at which the fat and oil turns into a liquid, and the storage container is filled with the fat and oil. In the step of fixing the position of the filling material, for example, by lowering the temperature of the fat and oil to a temperature at which the fat and oil turns into solid, the fat and oil is transitioned to the solid state. Examples of such a fat and oil to be use include edible fats and oils such as lard and margarine, various industrial fats and oils, and the like. These materials to be used may include a material which does not have an adverse effect, such as impregnation, dissolution, and discoloration, on the three-dimensional object.

According to the present disclosure, for example, it is possible to appropriately package the three-dimensional object.

### BRIEF DESCRIPTION OF THE DRAWINGS

FIGS. 1A to 1C are diagrams for explaining an example of a packaging method according to an embodiment of the present disclosure. FIG. 1A shows an example of a member used for an object to be packaged and a packaging in this example. FIG. 1B is a diagram for explaining an operation of accommodating a molded object 50, a filling material 120, and a cushioning material 140 in a storage container 100. FIG. 1C is a diagram for explaining a state in which the molded object 50, the filling material 120, and the cushioning material 140 are accommodated in the storage container 100 and a lid 106 is closed.

FIGS. 2A to 2C are diagrams for explaining a modification of a packaging method. FIGS. 2A to 2C show various modifications of the packaging method.

FIGS. 3A to 3C are diagrams for explaining a modified example of a packaging method. FIGS. 3A to 3C show the same features as those in FIGS. 1A to 1C regarding features of this modification.

FIGS. 4A to 4B are diagrams for explaining an experiment performed by the inventor of the present application. FIG. 4A is a diagram for explaining a transport test carried out in a packaging form for packaging using a powdery filling material 120. FIG. 4B is a diagram for explaining a comparative experiment.

FIG. 5 is a diagram showing results of experiments carried out using various filling materials 120.

### DETAILED DESCRIPTION OF EMBODIMENTS

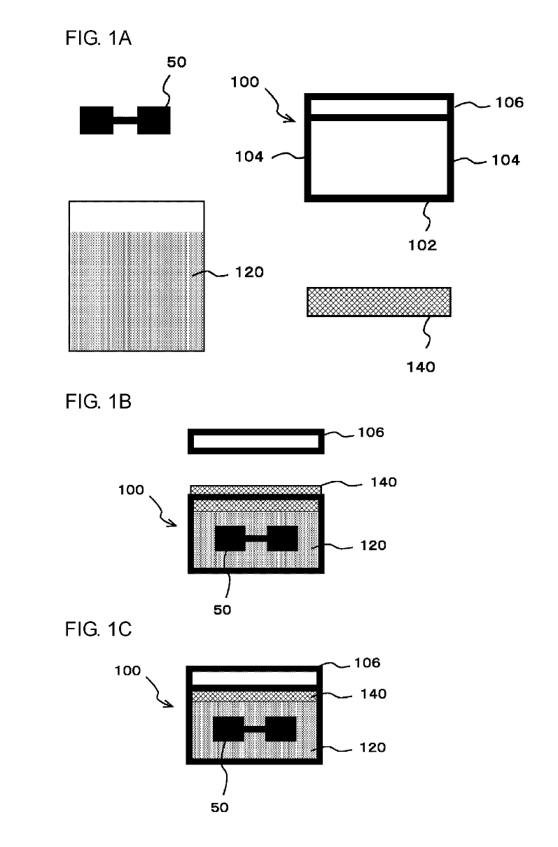

Hereinafter, embodiments of the present disclosure will be described with reference to the drawings. FIGS. 1A to 1C is a diagram for explaining an example of a packaging method according to an embodiment of the present disclosure. FIG. 1A shows an example of a member used for an object to be packaged and a packaging in this example. A packaging method of this example is a method of packaging a molded object 50 for transporting the molded object 50 which is an example of a three-dimensional object or for long-term storage, and uses a storage container 100, a filling material 120, and a cushioning material 140 to package the molded object 50. In this case, the packaging is, for example, packaging an object for transportation or long-term storage. The three-dimensional object is a stereoscopic object.

Further, among components shown in FIG. 1A, the molded object 50 is a three-dimensional object molded by a molding apparatus (three-dimensional molding apparatus). In this case, as the molding apparatus, for example, a molding apparatus that performs molding by an inkjet stacking method by stacking ink layers formed by an inkjet head in a plurality of layers, a molding apparatus that performs molding by a powder stacking method, or the like can be suitably used. As will be described in detail below, in this example, the packaging is performed to prevent the molded object 50 from being damaged. Therefore, it is conceivable to use, for example, a molded object having a fragile part as the molded object 50. More specifically, as the molded object 50, for example, a molded object having a thin portion of a thickness of 10 mm or less (for example, about 1 to 10 mm) may be used. Further, a thickness of the fragile part of the molded object 50 may be, for example, 5 mm or less (for example, about 1 to 5 mm). As an object to be packaged to be described below, it is also conceivable to use a three-dimensional object other than the molded object 50. More specifically, for example, in the case of transporting a model or the like which may be susceptible to damage during transportation, the model may be the object to be packaged.

Among the configuration shown in FIG. 1A, the storage container 100, the filling material 120, and the cushioning material 140 are examples of members used for packaging the molded object 50. Among them, the storage container 100 is a container (packaging container) for accommodating the molded object 50 at the time of the packaging. In this example, the storage container 100 is a container having a fixed shape. In this case, the storage container having a fixed shape is not a deformable container such as a plastic bag or the like, but a container that keeps a fixed shape even when the contents are emptied (a hard container). With respect to the storage container 100, the “fixed shape” may be substantially a fixed shape according to accuracy required for packaging. In this case, as described below, if the storage container 100 can keep a sufficiently fixed shape in a state in which it is filled with the filling material 120, the storage container 100 may be deformed to some extent, for example, before and after it is filled with the filling material 120. More specifically, in this example, the storage container 100 is a box-shaped container having a bottom surface 102, side surfaces 104, and a lid 106. In this case, the bottom surface 102 and the side surfaces 104 are surfaces that constitute a main body portion of the storage container 100 that accommodates the molded object 50 and the like. In addition, the lid 106 is a member that covers an upper part of the main body portion of the storage container 100. As the storage container 100, for example, a container or the like which is made of a plastic, a glass, a metal, a wood, or a combination thereof can be suitably used.

The filling material 120 is a material to be filled in the storage container 100 at the time of packaging the molded object 50 and is accommodated in the storage container 100 together with the molded object 50 to fill the inside of the storage container 100 by fine filling so that extra spaces may not be formed in the storage container 100. In this case, the filling material 120 is filled with the fine filling so that for example, a volume of the filling material 120 included in a unit volume becomes the maximum volume determined according to the shape or the like of the filling material. In this case, the volume of the filling material 120 included in the unit volume is the volume of the portion occupied by the filling material 120 in the unit volume. Regarding the volume of the filling material 120, the maximum volume determined according to the shape or the like of the filling material 120 is, for example, the maximum volume in the state in which a collapse or the like of the filling material 120 does not occur. In this case, as the filling material, it is preferable to use an inelastic material. With this configuration, for example, it is possible to appropriately perform the filling by the fine filling without the collapsing of the filling material 120 or the like and without forming a space between the three-dimensional objects. With respect to the state in which the filling material 120 is filled by the fine filling, for example, it can also be conceivable that the filling material 120 is in the filling state or the like so that the filling material 120 around the molded object 50 adheres to the molded object 50 without substantially opening the space through which the filling material 120 moves with respect to the molded object 50. Although not shown, a part of the volume of the filling material 120 may be replaced by solid matters such as resin, metal, and wood chips. In this case, it is preferable to fill the solid matters at a position sufficiently separated from the molded object so that the solid matters do not come into contact with the molded object 50. In addition, a plurality of molded objects 50 may be accommodated in an area (in the volume of the filling material 120) in which the filling material 120 is filled in the storage container 100.

In this example, for example, a powder or granule material is used as the filling material 120. As the powder or granule, it is preferable to use powder or granule having property of fluidity. The fact that the powder or granule has fluidity means, for example, that a large number of powders and granules are an aggregate and have fluidity. As the filling material 120, for example, it is preferable to use a material that does not firmly adhere to the molded object 50 even when the filling material 120 comes into contact with the molded object 50 but is easily removed from the molded object 50. From such a viewpoint, it is preferable to use dried powder or granule as the filling material 120. More specifically, in this example, as the filling material 120, for example, silica gel granules (silica gel particles) are used.

In this case, for example, since the filling material 120 does not firmly adhere to the molded object 50, at the time of taking out the molded object 50 from the storage container 100 after transportation, for example, the filling material 120 may be removed by a soft brush or the like without performing water washing or the like, such that it is possible to appropriately take out the molded object 50 in a state in which the extra filling material 120 may not adhere to the molded object 50. The silica gel is not toxic and therefore can be disposed as general waste. Therefore, when the silica gel is used as the filling material 120, for example, from this viewpoint, it is possible to easily and appropriately remove the filling material 120 after necessary transportation and the like. In this case, since the filling material 120 absorbs moisture in the storage container 100, even when the molded object 50 which is swollen, degenerated, decomposed, discolored or the like due to, for example, moisture absorption, it is possible to appropriately prevent the above problems from occurring. The silica gel is available at relatively low price, and can be repeatedly used by heating and drying. Therefore, in this case, the cost of the filling material 120 can be appropriately reduced.

Here, in the case of using the granular filling material 120 as in this example, in order to prevent the molded object 50 from being damaged at the time of packaging or after packaging, it is preferable that a dimension of the filling material 120 (a size of the granule, a diameter of the particle) be sufficiently smaller than a dimension of the fragile part of the molded object 50. In this case, making the size of the filling material 120 sufficiently smaller than the dimension of the fragile part of the molded object 50 means, for example, that the size of the filling material 120 is smaller than a thickness of the thinnest part of the molded object 50 or a width of a narrowest part of the molded part 50. More specifically, it is preferable that the dimension of the filling material 120 be, for example, 2 mm or less. In this case, the dimension of the filling material 120 is, for example, a length of the longest linear distance in each granule used as the filling material 120. In addition, the dimension of the filling material 120 may be a substantial dimension which is statistically obtained like an average dimension, for example. Regarding the dimension of the filling material 120, for example, it can be considered as a design standard dimension or the like. Practically, the use of the filling material 120 having a dimension of 2 mm or less means that the dimension of the filling material 120 having a weight ratio of 90% or more (preferably, 95% or more, more preferably 99% or more) among a large number of filling materials 120 filled in the storage container is 2 mm or less. In addition, the dimension of the filling material 120 is more preferably 1 mm or less. In this example, the filling material 120 is stored in a sealed container such as a bag until filled in the storage container 100. When the molded object 50 is packaged, a necessary amount is filled in the storage container 100.

It is to be noted that the upper limit of the preferable dimension of the filling material 120 is considered to change depending on a material strength and fineness of the molded object 50 which is an object to be packaged. In this case, theoretically, from the viewpoint of preventing the molded object 50 from being damaged, it is considered that the smaller the dimension of the filling material 120 is, the more preferable it is. In addition, the features of the filling material 120 will be described in more detail below with reference to FIGS. 1B and 1C.

The cushioning material 140 is a cushioning member accommodated in the storage container 100 together with the molded object 50 and the filling material 120. In this example, the cushioning material 140 is provided so as to come into contact with the filling material 120 from the outside in the storage container 100 and is used to apply a pressure to the filling material 120. As the cushioning material 140, a known cushioning material used for packaging can be suitably used. More specifically, as the cushioning material 140, for example, a polyurethane cushioning material, a polyurethane foam cushioning material, a sponge, an air cushion, cotton, or the like can be suitably used. The operation of applying the pressure to the filling material 120 by the cushioning material 140 will also be described in more detail below with reference to FIGS. 1B and 1C and the like.

FIG. 1B is a diagram for explaining an operation of accommodating the molded object 50, the filling material 120, and the cushioning material 140 in the storage container 100. In this case, the operation of accommodating the molded object 50 or the like in the storage container 100 is an example of the operation of the accommodating step. In this example, as shown in the drawings, the molded object 50 and the filling material 120 are accommodated in the storage container 100 so that the periphery of the molded object 50 is surrounded by the filling material 120. In this case, surrounding a periphery of the molded object 50 by the filling material 120 means, for example, that the molded object 50 is buried in the filling material 120 to surround the entire circumference of the molded object 50 by the filling material 120. In addition, in FIG. 1B, for convenience of illustration, by showing a cross section of the storage container 100 in which the molded object 50 is accommodated, the state in the storage container 100 is shown so that the molded object 50 can be seen. However, at the time of the actual packaging, for example, even in the case of using the storage container 100 having transmittance, the storage container 100 is surrounded by the filling material 120 so that the molded object 50 may not be seen from the outside of the storage container 100.

As described above, in this example, as the filling material 120, the granule of the silica gel is used. In this case, for example, the filling material 120 is filled from the bottom surface of the storage container 100 to a certain height by pouring the filling material 120 into the storage container 100, and then the molded object 50 is provided thereon. It can be considered to further add the filling material 120 from the top of the storage container 100. In this case, it is preferable to add the filling material 120 sufficiently gently so as to prevent the molded object 50 from being damaged due to the momentum of pouring the filling material 120 after the molded object 50 is provided.

Further, in this example, the cushioning material 140 is provided on the filling material 120 after the molded object 50 and the filling material 120 are accommodated in the storage container 100. In this case, for example, as shown in the drawing, the cushioning material 140 is provided so that at least a part of the cushioning material 140 protrudes from an opening portion which is closed by the lid 106 without completely fitting into the main body portion of the storage container 100. In the case of such a configuration, for example, by closing the lid 106 of the storage container 100, the cushioning material 140 sandwiched between the filling material 120 and the lid 106 is pressed against the lid 106, thereby pressing the filling material 120 from one direction. As a result, a pressure is applied to the filling material 120 in the storage container 100.

Regarding the pressure applied at this time, for example, it can be considered to set strength at which the molded object 50 does not move within the range of the shock assumed during transportation or the like. With such a configuration, for example, even when the storage container 100 is applied with a shock during transportation or the like, these positions can be appropriately fixed so as not to move the molded object 50 and the filling material 120. In order to apply such pressure, it can be considered that the cushioning material 140 has a compression degree close to a solid. For example, in the case where the filling material 120 is sufficiently filled in the storage container 100, the lid 106 is closed and the entire filling material 120 is fixed by utilizing elasticity (swelling) of the storage container 100 or the lid 106, the filling material can be applied with a sufficient pressure even when the cushioning material 140 is not used. Therefore, in such a case, the cushioning material 140 may be omitted. In addition, the reason for applying such pressure in this example is to appropriately fix the position of the molded object 50 or the filling material 120, as described above. Therefore, for example, in the case of using the filling material 120 whose position is appropriately fixed without being applied with a pressure, it is not necessary to apply a pressure.

FIG. 1C is a diagram for explaining a state in which the molded object 50, the filling material 120, and the cushioning material 140 are accommodated in the storage container 100 and the lid 106 is closed. As described above, in this example, by closing the lid 106 of the storage container 100 and sandwiching the cushioning material 140 between the filling material 120 and the lid 106, the filling material 120 is applied with a pressure. In this case, a force of a reaction against an action to press the granular filling material 120 by the cushioning material 140 is applied, and a force pressing against the molded object 50 surrounded by the filling material 120 from all directions (omnidirection) is generated. In addition, as a result, the positions of the filling material 120 and the molded object 50 are fixed in the storage container 100, and thus the filling material 120 and the molded object 50 do not move.

In this case, the operation of fixing the positions of the filling material 120 and the molded object 50 in the storage container 100 is an example of the operation of fixing the position of the filling material. The operation of fixing the position of the filling material is, for example, an operation of preventing at least a part of the filling material 120 from moving with respect to the molded object 50 in the storage container 100. In this case, “to prevent the filling material 120 from moving with respect to the molded object 50” means that for example, at least the filling material 120 coming into contact with the molded object 50 does not move relative to the molded object 50 when the storage container 100 is applied with a shock less than or equal to a preset magnitude. Regarding the shock applied to the storage container 100, a shock which is less than or equal to the preset magnitude is, for example, a shock less than or equal to the upper limit which is set according to required shock resistance. In addition, the shock of the upper limit is, for example, a shock which is assumed according to the situation during transportation or the like. The shock assumed according to the situation during transportation or the like is, for example, a shock corresponding to a standard shock or an inertial force applied during transportation. In addition, the state in which the filling material 120 does not move relative to the molded object 50 when the storage container 100 is applied with the shock less than or equal to the preset magnitude may be the state in which the filling material 120 or the molded object 50 moves within the storage container 100 when the storage container 100 is applied with a shock (for example, an unexpected impact) exceeding the preset magnitude. In addition, the state in which the filling material 120 does not move relative to the molded object 50 when the storage container 100 is applied with the shock less than or equal to the preset magnitude can be considered as, for example, the state in which the filling material 120 does not move as long as at least the storage container 100 is tilted to some extent. In this case, tilting the storage container 100 means tilting the storage container 100, for example, compared with the timing at which the filling material 120 is filled. In addition, the state of tilting of the storage container 100 is tilted is, for example, a state in which the bottom surface of the storage container 100 is tilted by about 45° with respect to a horizontal surface.

As described above, in this example, as the filling material 120, the granular silica gel is used. As the silica gel, the granular structure (particles of the silica gel) having low fluidity is used. In this case, it can be considered that the filling material 120 filled in the storage container 100 is in a state in which the pressure is equally propagated in the storage container 100. Evenly propagating the pressure in the storage container 100 means that for example, the pressure is not propagated along a limited small number of paths, but the pressure is equally propagated in all directions in the storage container 100 by being equal or similar to the pressure propagated in the liquid according to the characteristics of fluidity. In this case, when the cushioning material 140 is pressed against the filling material 120 by the lid 106 to apply the pressure to the filling material 120, the pressure is equally propagated within the region filled with the filling material 120 in the storage container 100 and the molded object 50 is uniformly pressed from all directions. For example, This makes it possible to appropriately realize a state in which the filling material 120 or the molded object 50 does not easily move within the storage container 100, for example. Such a state can be considered to be the state in which the filling material 120 does not move with respect to the molded object 50, or the like. In addition, in this case, regarding the operation of applying the pressure to the filling material 120, for example, regarding the filling material 120 around the molded object 50, it can be considered as the operation of fixing the relative position with respect to the molded object 50 in direct contact with the molded object 50, or the like. In such a state, for example, by filling the peripheral space of the molded object 50 with the filling material 120 by uniformly pressing the molded object 50 from all directions, the state in which the molded object 50 or the filling material 120 is prevented from moving in the storage container 100, or the like can be considered.

As described above, in this example, as the storage container 100 constituting an outline of the packaging, a container having a fixed shape that is not easily deformed is used. In this case, it is possible to more appropriately prevent a movement (creep) of the molded object 50 or the filling material 120, which is the contents of the storage container 100, during the transportation of the storage container 100, or the like, and to appropriately keep the state of the molded object 50 and the periphery of the molded object to be the fixed state. Therefore, according to this example, it is possible to appropriately prevent the molded object 50 from being damaged even when the storage container 100 is applied with a shock during transportation or the like or is applied with an inertial force accompanied during transportation. In this case, since the filling material 120 having fluidity comes into close contact with the molded object 50 so as to realize the state in which the filling material 120 and the molded object 50 do not move relative to each other, it is possible to appropriately package the molded object 50 by the same procedure regardless of the shape of the molded object 50. In this case, the state in which the filling material 120 and the molded object 50 do not move relative to each other means that one of the filling materials 120 and the molded object 50 does not move relative to the other of the filling material 120 and the molded object 50. In this case, since the molded object 50 can be appropriately packaged without using a blister case for transportation or the like, it is also possible to appropriately package the molded object 50 having various shapes at low cost. Therefore, according to this example, it is possible to suitably package the molded object 50 having various shapes molded by the molding apparatus in a state in which the molded object is unlikely to be damaged.

The inventor of the present application performed the experiment that the molded object 50 molded by the molding apparatus, which performs the molding by an inkjet method using an ultraviolet curable ink, is packaged using a polypropylene storage container 100 and the silica gel filling material 120 in the state shown in FIG. 1C and is kept for 10 days under vehicle transportation of 500 km and environment of 60° C. In such an experiment, it was confirmed that no abnormalities such as damage, deformation, and discoloration occur in the molded object 50.

Here, in the above description, the case in which the silica gel is mainly used for the filling material 120 used for packaging has been described. However, it is also conceivable to use various materials other than the silica gel as the filling material 120. As the filling material 120, it can be considered to use powder or granule of desiccant other than the silica gel as the filling material 120. In this case, it can be considered to use, for example, powder or granule of a chemical desiccant such as calcium oxide or calcium chloride, or a physical desiccant such as aluminum oxide, zeolite, and molecular sieve. Even in this case, it is possible to appropriately reduce the cost of the filling material 120, for example, by using the relatively inexpensive filling material 120. Apart from the desiccant, the filling material 120 made of various organic materials or inorganic materials can be used according to the conditions and the like required for packaging. More specifically, as such a filling material 120, for example, starch or the like can be suitably used. It is also conceivable to use, for example, wheat flour or salt. By using powder or granule of such food as the filling material 120, it is possible to appropriately use the filling material 120 having high safety, for example. In addition to these, as the filling material 120, it can be considered to use an inorganic material such as sand. In this case, for example, it can be considered to use inexpensive and easy-to-obtain sand such as commercially available river sand. As the filling material 120, it can be considered to use powder or granule such as silica sand, sand iron, quick lime, magnesium sulfate, burnt alum, sodium hydroxide, potassium carbonate, potassium hydroxide, sodium sulfate anhydrous salt, copper sulfate anhydrous salt, and magnesium perchlorate. As the filling material 120, it can be considered to use powder or the like which is commercially available as, for example, a gardening product. Even in this case, it is possible to use the filling material 120 that is inexpensive and easy to obtain. More specifically, as such a filling material 120, it can be considered to use, for example, a material such as pearlite which is foamed powder (artificial foam) commercially available as the gardening product or the like and vermiculite which is powder commercially available as the gardening product or the like.

As the filling material 120, it can be considered to use, for example, a resin or the like. In this case, for example, it is possible to appropriately reduce a weight of the filling material 120. For example, this makes it possible to appropriately suppress an increase in weight due to filling of the filling material 120. More specifically, in this case, it can be considered to use, for example, a foamed resin as the filling material 120. In addition, as such a filling material 120, it can be considered to use particles of a resin foam such as polyurethane, polystyrene, polyethylene, polypropylene, and PET. In this case, it is preferable to use the particles of the resin foam subjected to a non-charging treatment. In addition, as the filling material 120 of the resin, it can be considered to use, for example, a hollow resin. In this case, the hollow resin is, for example, a hollow pipe-shaped resin. As the hollow resin, the hollow resin made of, for example, polyethylene, polypropylene, PET or the like can be suitably used. In this case, it can be considered to use, for example, a hollow pipe-shaped particles having a diameter of about 4 mm or less (for example, about 1 to 4 mm, preferably about 2 to 3 mm) and a length of 6 mm or less (for example, about 2 to 6 mm, preferably about 3 to 5 mm). In this case, it is preferable that a thickness of the hollow pipe-shaped resin be, for example, about 0.1 mm (for example, about 0.05 to 2 mm). As the filling material 120, one kind of filling material 120 is not used, but plural kinds of filling materials 120 may be used in combination.

Subsequently, a modification or the like of the packaging method of the molded object 50 will be described. In the above description, the case in which the periphery or the like of the molded object 50 in the storage container 100 are filled with only the powder or granule filling material 120 has been described. However, in the modification of the packaging method, materials other than the filling material 120 of powder or granule may be further used to fill the periphery or the like of the molded object 50. In this case, it can be considered to further fill at least a part of the space between the filling materials 120 with a liquid in the operation of accommodating the molded object 50 or the filling material 120 in the storage container 100. It is particularly preferable to fill such a liquid, for example, the granular filling material 120. With such a configuration, for example, even when a slight space is generated between the individual filling materials 120 only by filling the filling material 120 such as granules, it is possible to appropriately bury the space with the liquid. This makes it possible to appropriately prevent the movement of the contents of the storage container 100.

Here, when a liquid is filled in addition to the filling material 120, if an amount of the liquid is too large, there is a possibility that the movement of the contents of the storage container 100 is likely to occur. Therefore, it is preferable to set the amount of the liquid to be an amount in a range within which only the packaging material 120 is in a state of fine filling. The fact that the filling material 120 is in the state of fine filling means that the filling material 120 is finely filled in the storage container 100 even when no liquid is filled, for example. Regarding how to fill the liquid, for example, it is preferable to fill the liquid so that the liquid reaches the space between the filling materials 120 around the molded object 50. As the liquid to be used in combination with the filling material 120 in this way, a liquid having a specific gravity of 2 or more or a liquid having a viscosity of 0.04 Pa·s or more can be suitably used. As such a liquid, it can be considered to use, for example, glycerin, silicon oil, tetrabromoethane or the like.

Further, when filling the storage container 100 with the filling material 120 and the liquid, it can be considered to fill the storage container 100 with the filling material 120 and then fill the storage container 100 with the liquid at the timing when each of the filling material 120 and the liquid is filled. With such a configuration, for example, it is possible to appropriately fill the liquid through the space between the filling materials 120 which is finely filled. Depending on the shape of the molded object 50 to be packaged and the conditions required for packaging, for example, it can be considered to simultaneously fill the filling material 120 and the liquid. With this configuration, for example, the filling material 120 and the liquid can be more uniformly filled in the storage container 100. In addition, for example, it is also conceivable to fill the storage container with the filling material 120 after filling a predetermined amount of liquid.

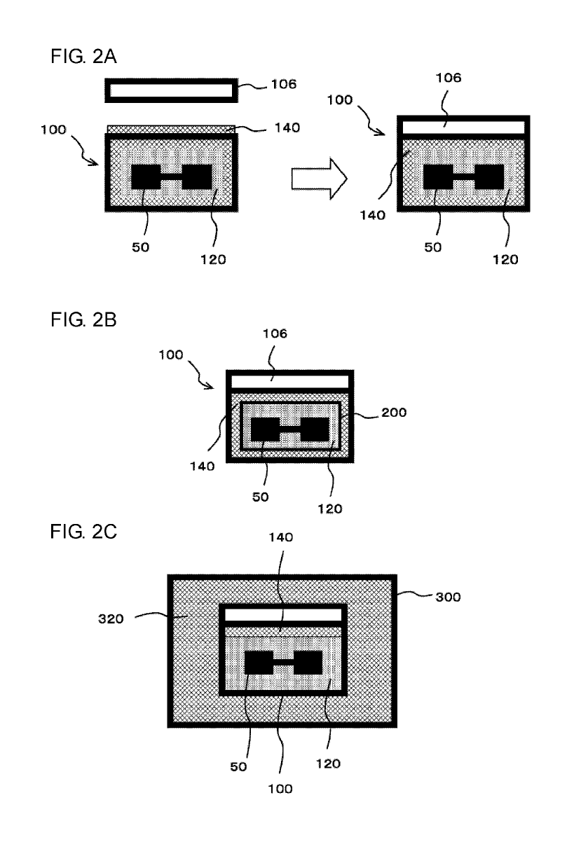

Various changes can also be made with respect to the way of filling the filling material 120 in the storage container 100, the operation to be performed after closing the lid of the storage container 100, and the like. FIGS. 2A to 2C are diagrams for explaining a modification of a packaging method. FIGS. 2A to 2C show various modifications of the packaging method. It is to be noted that, except for the points to be described below, in FIGS. 2A to 2C, the components represented by the same reference numerals as FIG. 1 may have the same or similar features to those in FIG. 1.

In the above description, a method for providing the cushioning material 140 to be used at the time of packaging at a position in contact with the lid 106 of the storage container 100 will be mainly described with reference to FIGS. 1B and 1C. However, the cushioning material 140 may be provided at a position other than the position in contact with the lid 106 within the storage container 100. More specifically, in this case, for example, as shown in FIG. 2A, it can be considered to provide the cushioning material 140 at a position in contact with a bottom surface or side surfaces of the storage container 100. With this configuration, for example, since the volume to be filled with the filling material 120 in the storage container 100 is reduced, the usage amount of the filling material 120 can be reduced. Even in this case, as shown on the left in the drawing, the cushioning material 140 is provided at a portion in contact with the lid 106 of the storage container 100, for example, as shown in the left in the drawing, so that at least a part of the cushioning material 140 protrudes from an opening portion closed by the lid 106 later. Even in this case, as shown on the right in the drawing, it is possible to appropriately apply a pressure to the filling material 120 in the storage container 100 by closing the lid 106. For example, this makes it possible to appropriately realize a state in which the filling material 120 or the molded object 50 does not easily move within the storage container 100.

When the cushioning material 140 is also provided at the position in contact with the bottom surface and the side surfaces of the storage container 100 as described above, it can be considered that the cushioning material 140 and the filling material 120 are not in direct contact with each other. More specifically, in this case, for example, as shown in FIG. 2B, it can be considered to use a bag 200 accommodating the molded object 50 and the filling material 120. As the bag 200, for example, a polyethylene bag or the like can be suitably used. In this case, for example, the bag 200 is provided in the storage container 100 from the opening portion of the storage container 100 in the state where the cushioning material 140 is provided at a position in contact with the bottom surface or the side surfaces of the storage container 100. In this case, it is conceivable to put the filling material 120 and the molded object 50 into the bag 200 so that the molded object 50 is completely buried in the filling material 120 and close the opening portion of the bag 200 with a tape or the like. With this configuration, for example, it is possible to appropriately prevent the fine powdery or granular filling material 120 from putting into the cushioning material 140 or the like. In this case, it is preferable that the operation of putting the molded object 50 and the filling material 120 into the bag 200 be performed after putting the bag 200 into the storage container 100. With this configuration, for example, it is possible to more stably keep the state after the molded object 50 and the filling material 120 is put into the bag 200.

In order to more reliably protect the molded object 50 from the shock and the like during transportation, it is preferable not only to put the filling material 120, the cushioning material 140, or the like into the storage container 100 but also to further provide a cushioning material 320 around the storage container 100 as show in FIG. 2C, for example. More specifically, in this case, as shown in the drawing, for example, an exterior member 300 covering the outside of the storage container 100 and a cushioning material 320 are further used to perform multiple packaging. As the exterior member 300, for example, a cardboard box or the like having a size capable of accommodating the storage container 100 therein can be suitably used. In this case, the cushioning material 320 is filled between the storage container 100 and the exterior member 300 in the same manner as, for example, the packaging material used in a known packaging method or the like. As the cushioning material 320, for example, a known cushioning material for packaging such as a foaming material and a cushioning material can be suitably used. In this case, the operation of providing the storage container 100 and the cushioning material 320 in the exterior member 300 is an example of the operation of covering the storage container and the cushioning material. In addition, the operation of covering the storage container and the cushioning material is, for example, an operation of covering the storage container 100 and the cushioning material 320 with the exterior member 300 so that at least a part of a periphery of the storage container 100 comes into contact with the cushioning material 320. With such a configuration, it is possible to more appropriately prevent the molded object 50 from being damaged or the like due to the shock or the like during transportation.

In the above description, the example of the packaging method in the case of using the powdery or granular filling material 120 was described. However, as the filling material, it is also conceivable to use materials other than the powder or grain. More specifically, in this case, for example, it is conceivable to use a material or the like which undergoes a phase transition from a liquid state to a solid state in the packaging operation as the filling material.

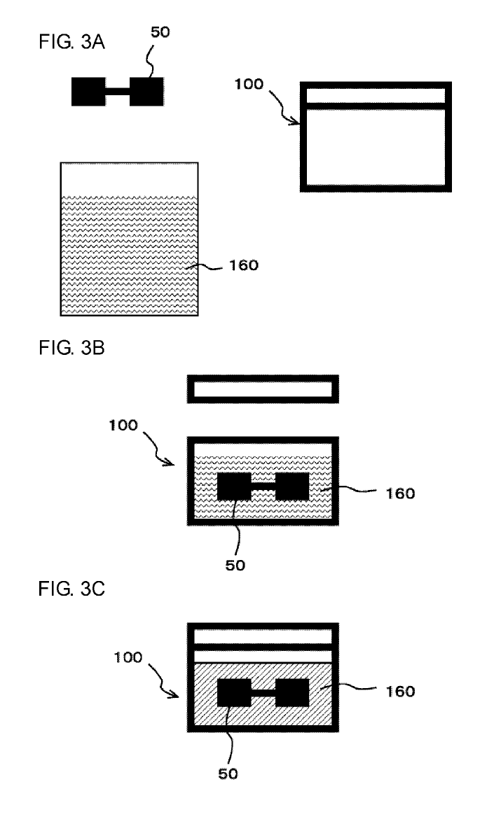

FIGS. 3A to 3C are diagrams for explaining another modifications of a packaging method. FIGS. 3A to 3C show the same features as those in FIGS. 1A to 1C regarding features of this modification. It is to be noted that, except for the points to be described below, in FIG. 3, components represented by the same reference numerals as FIGS. 1 and 2 may have the same or similar features to those in FIGS. 1 and 2. In addition, a filling material 160 used in this modification may have the same or similar features as those of the filling material 120 described with reference to FIG. 1 or 2, except as described below.

In this modification, as the filling material 160 to be filled in the storage container 100, a material which undergoes a phase transition from a liquid state to a solid state during a packaging operation is used, not a powder or granular material. In this case, the state of the liquid is, for example, a state of fluidity that can be poured into the storage container 100. In this case, the filling material 160 is in the liquid state when filled in the storage container 100. More specifically, in this modification, for example, as shown in FIG. 3A, the molded object 50 is packaged by using the storage container 100 and the filling material 160. In this case, for example, as shown in FIG. 3B, by filling the filling material 160 in the liquid state in the storage container 100, the molded object 50 and the filling material 160 are accommodated in the storage container 100 so that the periphery of the molded object 50 is surrounded by the filling material 160. In this case, after the molded object 50 and the filling material 160 are accommodated in the storage container 100, for example, the temperature of the filling material 160 is lowered to change the state of the filling material 160 into the solid state. Even in such a case, by filling the inside of the storage container 100 in the solid state without a space and surrounding the periphery of the molded object 50, it is possible to appropriately prevent the molded object 50 and the filling material 160 from moving in the storage container 100. This makes it possible to appropriately prevent the molded object 50 from being damaged.

Here, as such a filling material 160, for example, it is preferable to use a material which is in a liquid state at a temperature within a range not affecting the molded object 50 and keeps the solid state at a temperature at the time of transportation of the molded object 50. In this case, the temperature within the range not affecting the molded object 50 is, for example, a temperature at which the molded object 50 does not cause softening, deterioration, or the like. In addition, the temperature at the time of transportation of the molded object 50 is, for example, the temperature of the environment in which the molded object 50 is stored during transportation. In this case, considering a temperature in a vehicle for transportation or the like, it is conceivable that the temperature at the time of transportation is, for example, about 50° C. at the maximum. When the transportation is performed in the more stable environment, the temperature during transportation can be regarded to be, for example, about 30° C. For example, when transporting the molded object 50 while keeping the molded object 50 at a predetermined low temperature, the temperature can be regarded as the temperature during transportation. More specifically, as such filling material 160, for example, starch or the like can be suitably used. In this case, at the time of filling the storage container 100 with the filling material 160, for example, the temperature of the fat and oil used as the filling material 160 is set to be a temperature at which the fat and oil becomes a liquid, and the storage container 100 is filled. After that, by lowering the temperature of the fat and oil to a temperature at which the fat and oil becomes a solid, the fat and oil is transitioned to the solid state. Examples of such a fat and oil to be used include edible fats and oils such as lard and margarine, various industrial fats and oils, and the like.

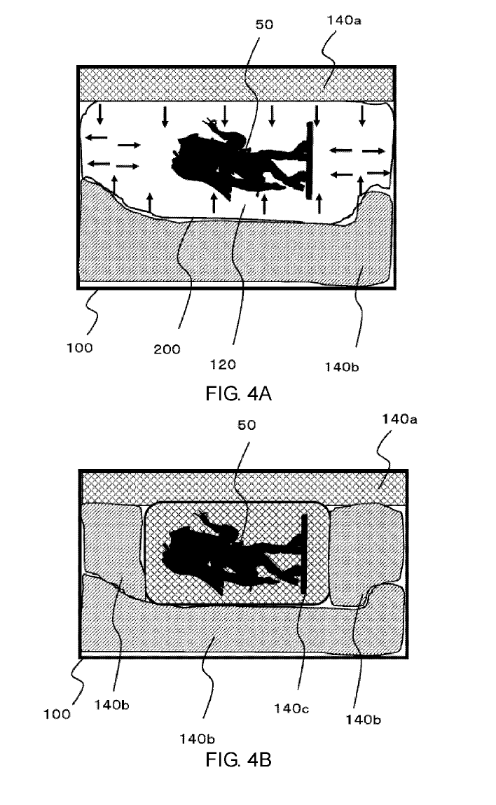

Next, an experiment (transportation test) performed by the inventor of the present application will be described. FIGS. 4A to 4B are diagrams for explaining an experiment performed by the inventor of the present application. FIG. 4A is a diagram for explaining a transportation test carried out in a packaging form for packaging using a powdery filling material 120. In the above description performed using FIGS. 1 to 3, for convenience of illustration and explanation, a part of the packaging method is briefly explained. In the specific packaging method described below, for the sake of experimental convenience, the method is partly different from the method described above. However, as is apparent from the following description, the basic features relating to preventing the molded object 50 from being damaged are the same as or similar to those described above.

More specifically, in this experiment, for example, in the same manner as in the case described with reference to FIG. 2B, a polyethylene bag 200 was used, and the filling material 120 and the molded object 50 were put into the bag 200 so that the molded object 50 is completely buried in the filling material 120. In order to prevent the filling material 120 and the like from leaking to the outside from the space of the opening portion of the bag 200, the opening portion of the bag 200 is closed with a tape. In this experiment, as the filling material 120, as an example of the powdery material, the starch was used. The reason for using the starch is not harmful to the human body and is easy to dispose after use.

As shown in the drawing, as the cushioning material, a plurality of cushioning materials 140a and 140b are used as the cushioning material. Among them, the cushioning material 140a is a cushioning material for uniformly applying a pressure to the filling material 120 in the bag 200 and is provided on an upper side of the bag 200 as shown in the drawing. As the cushioning material 140a, a polyethylene bubble cushioning material was used. In addition, the cushioning material 140b is a cushioning material used for reducing the usage amount of the filling material 120 by being provided in the storage container 100. As the cushioning material 140b, a polyethylene bubble cushioning material was used. As shown in the drawing, the cushioning material 140b was installed on a lower side of the bag 200 in the storage container 100. As the storage container 100, a general cardboard box was used.

As described above, it is preferable to use a container having a fixed shape as the storage container 100. Therefore, as the storage container 100, it is more preferable to use a container formed of a harder material such as a plastic, a glass, a metal, a wood or the like. However, if the fixed shape can be kept appropriately during transportation, as described above, even the cardboard box or the like can be used as the storage container 100.

When the packaging is performed as shown in FIG. 4A, by closing the lid of the storage container 100, the filling material 120 in the bag 200 is pressed by the cushioning material 140a. In this case, a force of a reaction against an action to allow the cushioning material 140a against the filling material 120 is applied, such that the filling material 120 around the molded object 50 generates a force to press the molded object 50 from all directions. As a result, the filling material 120 does not move in the storage container 100 and thus the movement of the molded object 50 also does not occur. As described above, this makes it possible to appropriately realize the state in which the damage to the molded object 50 is unlikely to occur during the transportation of the molded object 50. In addition, the inventor of the present application performed the experiment to perform packaging in the state shown in FIG. 4A and perform transportation plural times by actually using the molded object 50 of a figure having a fine structure of a finger portion, a hair shape or the like. And it was confirmed that the transportation can be carried out appropriately without breaking the molded object 50.

The inventor of the present application further performed comparative experiment to perform packaging and transportation in another state in order to more appropriately confirm the effect of the packaging in the state shown in FIG. 4A. FIG. 4B is a diagram for explaining the comparative experiment. In this comparative experiment, in the case shown in FIG. 4A, a cushioning material 140c which is a polyethylene bubble cushioning material is used for the portion filled with the filling material 120 so that the cushioning material 140c surrounds the molded object 50, thereby protecting the molded object 50. In addition, the cushioning material 140a, which is the polyethylene bubble cushioning material, was provided thereon, such that the molded object 50 and the cushioning material 140c are fixed so as not to move.

Even in this case, the molded object 50 is wrapped with the polyethylene foam cushioning material (cushioning material 140c) together with air. This makes it possible to obtain a force to press the molded object 50 in the storage container 100 so that the molded object 50 does not move and a cushion effect is provided by the cushioning material 140c. In this case, however, the reaction of the force is generated by the molded object 50 itself. In this case, for example, when a force is applied to move the molded object 50 due to a shock or the like during the transportation of the molded object 50, a force may concentrate on a specific portion of the molded object 50. As a result, it can be considered that the fine structure portion or the like is liable to be damaged. In fact, the inventor of the present application performed an experiment to perform the packaging and the transportation plural times in the state shown in FIG. 4B. It was confirmed that the damage to the molded object 50 is liable to occur as compared with the case of performing the packaging in the state shown in FIG. 4A. It was confirmed that, by doing so, the packaging is performed in the state shown in FIG. 4A to obtain the effect of preventing the molded object 50 from being damaged.

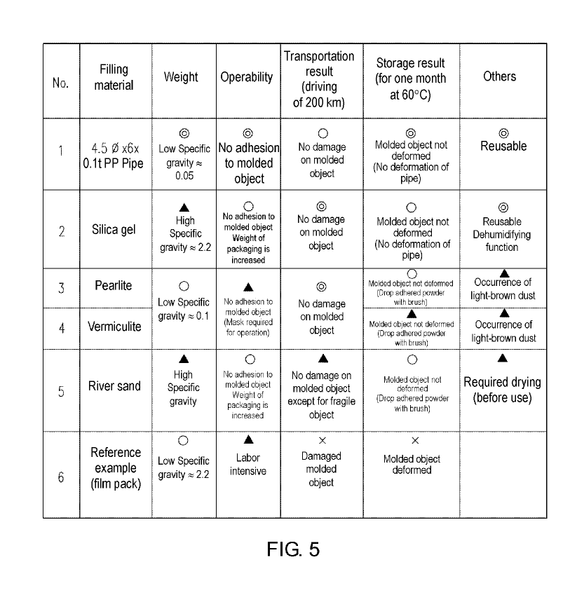

The inventor of the present application further performed an experiment in the case of using various filling materials 120 other than the starch. FIG. 5 is a diagram showing results of an experiment performed using various filling materials 120. In this experiment, the transportation test and the storage test were performed using various filling materials 120 as indicated by numbers 1 to 5 in the figure. In this transportation test, except for the filling material 120 to be used, the packaging was performed in the same manner as in the case described with reference to FIG. 4, and the vehicle transportation of 200 km was performed. In the storage test, the storage was performed for one month in the environment of 60° C. As the object to be packaged, the molded object 50 having a doll (figure) shape was used. As a reference example for comparison with the case of performing the packaging using the filling material 120, as indicated by number 6, the packaging was performed out using a film pack, and the transportation test and the storage test were performed.

More specifically, in the figure, the filling material 120 indicated by number 1 is a hollow resin. As the hollow resin, a hollow pipe-shaped resin having a diameter of 4.5 mm, a length of 6 mm, and a thickness of a resin constituting a pipe of 0.1 mm was used. In this case, a specific gravity of the filling material 120 becomes an extremely small value of about 0.05. The specific gravity is, for example, a specific gravity so that a weight in the case in which one small cardboard box is filled is about 1 kg. Therefore, when such a filling material 120 is used, an increase in a weight due to the filling of the filling material 120 can be appropriately suppressed. In this case, the filling material 120 did not adhere to the molded object 50 which is the object to be packaged, and the operability was good. In addition, the results of the transportation test were good, and the results of the storage test were extremely good. Also, even when stored for a long period of time in the storage test, a pipe deformation and the like did not occur. In this case, the filling material 120 can be reused. From the above results, it can be understood that the hollow resin can be suitably used as the filling material 120.

The filling material 120 indicated by number 2 is silica gel. As the silica gel, commercially available silica gel was used as a desiccant for dry flowers. In this case, the specific gravity is larger than that of the hollow resin. However, even in this case, the operability at the time of the operation of the packaging was good. The results of the transportation test were very good. Although it was necessary to drop the filling material 120 from the molded object by using a brush or the like, the results of the storage test were good. Even in this case, the filling material 120 can be reused. From the above results, it is understood that the silica gel can also be suitably used as the filling material 120. Since the specific gravity of the filling material 120 of the silica gel is larger than that of the hollow resin as described above, it can be particularly suitably used even when the weight after the packaging is increased to some extent, the weight is permitted. Since the silica gel has a dehumidifying function and has characteristics that particles do not adhere to each other even under high temperature and high humidity, for example, the silica gel may be mixed with another filling material 120 and used. In this case, for example, the degeneration of the molded product 50 is suppressed even in the environment of high temperature and high humidity in the state in which a pressure is applied by the long-term transportation, and the adhesion of the filling material 120 to the surface of the molded object 50 can be suppressed. In this case, it is also possible to suppress the weight after the packaging from increasing.

The filling materials 120 indicated by reference numerals 3 and 4 are pearlite and vermiculite. As the pearlite and the vermiculite, pearlite and vermiculite which are commercially available as gardening products were used. In these cases, the specific gravity becomes small like the hollow resin. However, in these cases, as dust is generated, a mask is required at the time of the operation, and therefore the operability is low as compared with the hollow resin and the like. However, even in this case, the result of the transportation test was good. Although it was necessary to drop the filling material 120 from the molded object by using a brush or the like, the results of the storage test on the pearlite were good. In this case, the fact that the result of the storage test is generally good means that the molded object 50 can be appropriately stored, for example, except when the required level is severe. From the above results, it is understood that the pearlite and the vermiculite can also be suitably used as the filling material 120. As described above, the filling materials 120 of the pearlite and the vermiculite have lower operability than that of the hollow resin or the like, such that the filling materials can be particularly suitably used in the case in which the use of the mask is not a problem at the time of the operation.

The filling material 120 indicated by number 5 is river sand. As the river sand, river sand which is marketed as sand for plasterer was used. In this case, the specific gravity is larger than that of the hollow resin. However, even in this case, the operability at the time of the operation of the packaging was good. The results of the transportation test were generally good. In this case, the fact that the results of the transportation test are generally good means that the molded object 50 can be transported appropriately except when transporting a particularly fragile molded object 50. Although it was necessary to drop the filling material 120 from the molded object by using a brush or the like, the results of the storage test were good. From the above results, it is understood that even the river sand can also be suitably used as the filling material 120. Regarding the river sand, as described above, the results of the transportation test is somewhat worse as compared with the other filling material 120. When the river sand is used, a process of drying the river sand is required before the river sand is used. On the other hand, the river sand can be available at a lower price than other filling material materials 120. Therefore, the river sand can be particularly suitably used in the case of packaging a relatively fragile molded object 50 or the like at low cost.

As described above, reference numeral 6 in the figure indicates a reference example in which packaging is performed using a film pack. In this reference example, the molded object 50 was wrapped by the film pack and then sandwiched by urethane of 14×22×4 cm size to fix the molded object 50. In this case, it can be considered that the specific gravity of the film pack is sufficiently small. However, when the packaging is performed using the film pack, a labor required for the operation is increased, and therefore the operability is lowered. As shown in the figure, in this case, in the transportation test, the molded object 50 was damaged, and in the storage test, the molded object 50 was deformed. More specifically, in this case, in the transportation test, the damage to the finger portion of the doll used as the molded object 50 occurred. In the storage test, a doll's foot was deformed. By comparison with this reference example, for example, it can be understood that when the above-described various filling materials 120 are used, the packaging under the condition that the molded object 50 is not easily damaged or deformed can be appropriately realized.

The present disclosure can be suitably used for, for example, a packaging method for three-dimensional objects.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A packaging method for packaging a three-dimensional object which is a stereoscopic object, comprising:
a step of accommodating a three-dimensional object and a filling material in a storage container so that a periphery of the three-dimensional object is surrounded by the filling material by using the storage container, wherein the storage container accommodates the three-dimensional object and the filling material fills in the storage container; and
a step of fixing a position of the filling material to prevent at least a part of the filling material from moving relative to the three-dimensional object in the storage container when the storage container is applied with a shock less than or equal to a preset magnitude by fixing a relative position of at least the filling material around the three-dimensional object, wherein the three-dimensional object is in a state in which the filling material comes into contact with the three-dimensional object.

2. The packaging method according to claim 1, wherein the filling material is powder or granule, and
wherein in the step of fixing the position of the filling material, by performing fine filling on the filling material in the storage container, wherein the filling material which is in contact with at least the three-dimensional object does not move relative to the three-dimensional object even when the shock is applied to the storage container.

3. The packaging method according to claim 2, wherein in the step of accommodating the three-dimensional object and a filling material in a storage container, at least a part of a space between the filling materials is further filled with a liquid.

4. The packaging method according to claim 2, wherein the filling material has a dimension of 2 mm or less.

5. The packaging method according to claim 1, wherein the storage container has a fixed shape.

6. The packaging method according to claim 1, wherein the filling material is a silica gel particle.

7. The packaging method according to claim 1, wherein the filling material is a starch.

8. The packaging method according to claim 1, wherein the filling material is a hollow resin.

9. The packaging method according to claim 1, wherein the filling material is a pearlite or a vermiculite.

10. The packaging method according to claim 1, wherein in the step of accommodating the three-dimensional object and the filling material in the storage container, the filling material in a liquid state is filled in the storage container, and
wherein in the step of fixing the position of the filling material, the filling material is transitioned to a solid state.

11. The packaging method according to claim 10, wherein the filling material is a fat and oil,
in the step of accommodating the three-dimensional object and the filling material in the storage container, a temperature of the fat and oil is set to be a temperature at which the fat and oil becomes a liquid to fill the fat and oil in the storage container, and
in the step of fixing the position of the filling material, the fat and oil is transitioned to a solid state by lowering the temperature of the fat and oil to a temperature at which the fat and oil becomes solid.

12. The packaging method according to claim 1, wherein the three-dimensional object is a molded object which is molded by a molding apparatus.

13. The packaging method according to claim 1, further comprising:
a step of covering the storage container and the cushioning material with an exterior member wherein the exterior member covers an outside of the storage container and the cushioning material and bringing at least a part of a periphery of the storage container into contact with the cushioning material.

14. A packaging method for packaging a three-dimensional object which is a stereoscopic object, comprising:
a step of accommodating a three-dimensional object and a filling material in a storage container so that a periphery of the three-dimensional object is surrounded by the filling material by using the storage container wherein the storage container accommodates the three-dimensional object and the filling material which is powder or granule fills in the storage container; and
a step of fixing a position of the filling material to fix a relative position of the filling material around the three-dimensional object wherein the three-dimensional object is in a state in which the filling material comes into contact with the three-dimensional object.
